(19) United States
(12) Patent Application Publication
(10) Pub. No.: US 2026/0160307 A1
(43) Pub. Date: Jun. 11, 2026

(54) RAILWAY BRAKING SYSTEM AND RAILWAY VEHICLE PROVIDED WITH SUCH A SYSTEM

(71) Applicant: WABTEC Hauts-de-France, Amiens (FR)

(72) Inventors: Claudino Goncalves, Ribeaucourt (FR); Denis Gerber-Papin, L'Etoile (FR); Guillaume Bonhomme, Amiens (FR); Marc-Edward Ledoux, Amiens (FR)

(73) Assignee: WABTEC Hauts-de-France, Amiens (FR)

(21) Appl. No.: 18/723,621

(22) PCT Filed: Dec. 20, 2022
(86) PCT No.: PCT/FR2022/052436

§ 371 Date: Jun. 24, 2024

(30) Foreign Application Priority Data
Dec. 22, 2021 (FR) 2114200

(51) Int. Cl. F16D 65/18; B61H 5/00; F16D 55/224; F16D 66/00; F16D 127/06

(52) U.S. Cl. CPC F16D 65/18; B61H 5/00; F16D 55/2245; F16D 66/00; F16D 2066/003; F16D 2127/06

(57) ABSTRACT

The invention relates to a railway braking system including a brake cylinder, an actuation device configured to lock the brake cylinder in a braking position and an unlocking device configured to unlock the actuation device by actuation of a control mechanism which includes a control member movable in a first direction and housed in a casing of the unlocking device, and a blocking member mounted movable in a second direction perpendicular to the first direction and housed in the casing of the unlocking device, the control mechanism being configured so that, when the actuation device is in a locking position of the brake cylinder and the control member is urged and moved towards a maintenance position in which it is configured to make the actuation device pass into an unlocking position, the blocking member is urged and moved in a position in which it blocks the control member in position.

### TECHNICAL FIELD OF THE INVENTION

The invention relates to the field of railway vehicles. More particularly, it relates to a railway braking system for a railway vehicle.

The invention also relates to a railway vehicle including such a system.

For example, the railway braking system may include a brake cylinder configured to act on braking members of the vehicle, such as for example brake discs or directly on the wheels of the vehicle.

### PRIOR ART

Railway vehicles are generally equipped with brake cylinders each including a piston movable under the effect of a pressurised fluid, the movement of this piston causing a braking action such as clamping of a brake disc between two pads, or a direct pressure of a pad against a wheel of the vehicle.

These brake cylinders also generally include a parking actuator which is activated in the event of a drop in the pressure of the pressurised fluid, in the event of a voluntary emptying or leakage of the pneumatic system, and which allows ensuring braking thanks to the force of one or more spring(s) substituting for the force of the fluid. Once this actuator has been activated, the brake remains permanently clamped, whereas maintenance actions should be conducted, where appropriate, for example to identify and suppress the cause of the failure of the pressurised fluid circuit, or to proceed with the replacement of fittings.

However, it might be necessary, in particular during these maintenance operations, to move the railway vehicle, the actuator of which has been activated, and, for this purpose, it is necessary to unlock the actuator.

The document EP 2 154 040 discloses an actuation device for a vehicle wheel brake, this device including triggering means enabling locking of the brake when an action such as those mentioned hereinabove takes place. In particular, this consists of a parking or emergency brake actuator adapted to lock a railway brake cylinder. This actuator includes a push sleeve adapted to act on said brake cylinder, a slider movably mounted axially in the push sleeve between a locking position and an unlocking position, a piston adapted to be driven by elastic means and connected to a hooking member, and a plurality of balls arranged in an opening of the sleeve between the slider and the hooking member and controlled in position by a lateral surface of the slider. When the slider is in the locking position, the balls adopt a projecting position with respect to the sleeve where they are engaged in an indentation of the hooking member, and when the slider is in the unlocking position, adopt a retracted position with respect to the sleeve where they are cleared from the hooking member. When the slider is in the locking position, the hooking member axially drives the push sleeve and when the slider is in the unlocking position, the hooking member is axially uncoupled from the push sleeve. The lateral surface of the slider includes, for each ball, a respective locking indentation to fittingly receive this ball when the slider is in the locking position, each locking indentation being directed axially and having an arcuate-shaped cross-section with a radius similar to that of the ball. Thus, the ball is in contact with the surface of the locking indentation on an arcuate line.

In the document EP 2 154 040, the actuator further includes an unlocking device which is adapted to push the slider back into the push sleeve while compressing a spring arranged between the slider and the push sleeve. Hence, the unlocking device is adapted to drive the slider from its locking position to its unlocking position. In particular, a maintenance agent wishing to stop the braking force exerted by the actuator in order, for example, to move the vehicle towards its maintenance location, should proceeds with unlocking of the actuator thanks to the unlocking device and, for example, by pulling on a control cable.

In the document EP 2 154 040, the unlocking device includes a lever having a cambered base and a rod extending from the base. The cambered base is arranged and held between the top of the slider and an annular stop, the inner diameter of which is slightly smaller than that of the cambered base. This unlocking device also includes means for actuating the lever. These means include a sheath which partially wraps the rod and the closed end of which is crossed by a transverse journal. This journal is connected to a return spring which tends to return the sleeve and therefore the lever in the axis of the slider. The actuation means also include a rod connected to the journal. This rod extends transversely to the slider and could be driven in translation according to the direction thanks to an outer control member such as a handle connected to the control cable.

When a maintenance agent wishes to stop the braking force exerted by the actuator, all he/she has to do is to actuate the outer control member so as to move the rod causing the movement of the sleeve, and therefore of the lever, via the journal. The cambered base of the lever being held against the annular stop, the sleeve pivots about the journal whereas the lever slides in this sleeve and the cambered base tilts so that a portion of this base exerts a force on the top of the slider which is pushed back into its unlocking position. In other words, the engagement of the unlocking device drives the slider towards its unlocking position. Each ball is then pushed by the hooking member and is thus brought close to the axis of the slider up to the unlocking indentation corresponding to its retracted position. The profile of each groove allows preserving, throughout the movement of the corresponding ball, an arcuate shaped ball/groove contact line. As soon as the balls occupy their retracted position, the hooking member becomes axially uncoupled from the sleeve. As it no longer has any contact with the balls, the hooking member then slides axially relative to the push sleeve. The piston then abuts against the body whereas the push sleeve is free to slide along its longitudinal axis. The piston of the brake cylinder rises up to the high position and the brake cylinder is then in the released position.

Other actuation devices are known from the documents FR 2 473 440, EP 0 206 520 and BE 852 864.

### DISCLOSURE OF THE INVENTION

The invention relates to a railway braking system having in particular an actuation device as well as an unlocking device of the type described hereinabove, which is simple, convenient and economical both in manufacture and in use.

Thus, an object of the invention is, in a first aspect, a railway braking system for a railway vehicle, including a brake cylinder configured to act on braking members of the railway vehicle, an actuation device configured to lock the brake cylinder in a braking position and an unlocking device configured to unlock the actuation device by actuation of a control mechanism, characterised in that the control mechanism includes a control member movable in translation according to one direction and housed in a casing of the unlocking device connected to the brake cylinder, the control member being configured to cooperate with the actuation device, and a blocking member mounted movable in translation according to a direction perpendicular to the direction of movement of the control member and housed in the casing of the unlocking device, the control mechanism being configured so that, when the actuation device is in a locking position of the brake cylinder and the control member is urged and moved towards a maintenance position in which it is configured to make the actuation device pass into an unlocking position, the blocking member is urged and moved in a position in which it blocks the control member in position.

Thus, when a maintenance agent who has exerted a force to move the control member in order to unlock the actuation device, releases the exerted force, the control member remains in the maintenance position by the effect of the blocking member.

The control mechanism of the railway braking system according to the invention is particularly simple and compact as it combines, in the casing of the unlocking device, both the control member which cooperates with the actuation device and the blocking member which cooperates with the control member.

Preferred, simple, convenient and economical features of the railway braking system according to the invention are set out hereinafter.

The unlocking device includes at least one control rod connected at one end to the control member and mounted so as to partially project from the casing so as to be urged from the outside of the casing for example by a handle and/or a control cable.

The control member is formed by a clevis movably mounted in a space formed in a body of the casing, between a safety position, corresponding to locking of the brake cylinder, and a maintenance position corresponding to unlocking of the brake cylinder, with the clevis which has a central orifice configured to receive a lever of the actuation device.

The blocking member is formed by a U-shaped lock housed in a space formed in a body of the casing, with the lock which has a bottom wall from which project a first branch having at its free end a first flange which can be housed in a first cavity formed in the body, and a second branch extending opposite the first branch and having at its free end a second flange which can be housed in a second cavity formed in the body of the casing.

The clevis and the lock are sized so that the clevis is received at least partially in a space delimited between the first and second branches of the U-shaped lock.

The control mechanism has a control module provided with a control piston extending at least partially in a body of the casing, a control chamber supplied with pressurised fluid via a control orifice formed in the body of the casing and which is located, on the one hand in fluid communication with a groove formed in a body of the brake cylinder and, on the other hand, in fluid communication with the control chamber via a control line running at least in the body of the casing.

When the control chamber is supplied, the control piston is urged so that it pushes the lock so that the clevis could be housed therein, the first flange is housed in the first cavity, and in this safety position of the clevis, the lever of the actuation device is partially received in a central orifice of the clevis.

When the control chamber is no longer supplied and the clevis is driven in translation towards its maintenance position, it comes out from the space delimited between the first and second branches of the U-shaped lock, which is released and driven in translation by the control piston itself urged by a spring member and, in this maintenance position, the first flange comes out at least partially from the first cavity to be positioned under the clevis whereas the second flange is housed in the second cavity, thereby blocking the clevis in position.

The control piston is mechanically connected at one end to the second branch of the lock and the control module further has a return member mounted around the control piston and configured to urge it away from the space of the body, towards an outer cover of the control module, which outer cover delimits with the control piston the control chamber which is supplied with pressurised fluid.

The control mechanism has a detection module provided with at least one sensor housed in the body and configured to detect the position of the control member and/or of the blocking member.

The casing is herein made of a plastic material. Alternatively, the casing may be made of a moulded alloy or of a machined metal.

The system includes a parking brake and/or service brake cylinder configured to act on braking members of the vehicle, such as for example brake discs or directly on the wheels of the vehicle, with the actuation device which is configured to lock the brake cylinder in the parking brake configuration.

Another object of the invention is, in a second aspect, a railway vehicle including a railway braking system as described hereinabove, which is configured to act on mechanical members of the vehicle and the unlocking device of which is configured to unlock the actuation device by actuation of a control mechanism.

### BRIEF DESCRIPTION OF THE FIGURES

The disclosure of the invention will now be carried on by the description of some embodiments, given hereinafter for illustrative and non-limiting purposes, with reference to the appended drawings.

FIG. 1 schematically illustrates a railway braking system according to the invention.

FIG. 2 partially illustrates in perspective the railway braking system of FIG. 1.

FIG. 3 is a partial cross-sectional view referenced III-III in FIG. 2.

FIG. 4 is a median longitudinal sectional view of a control mechanism of the railway braking system of FIG. 1 to 3, in a so-called safety first configuration.

FIG. 5 is a view similar to that of FIG. 4, showing the control mechanism in a so-called maintenance second configuration.

FIG. 6 illustrates in section a first variant of the control mechanism, in its so-called locked first configuration.

FIG. 7 is a view similar to that of FIG. 6, showing the control mechanism in its so-called unlocked second configuration.

FIG. 8 illustrates in section a second variant of the control mechanism, in its so-called locked first configuration.

FIG. 9 is a view similar to that of FIG. 8, showing the control mechanism in its so-called unlocked second configuration.

### DETAILED DESCRIPTION

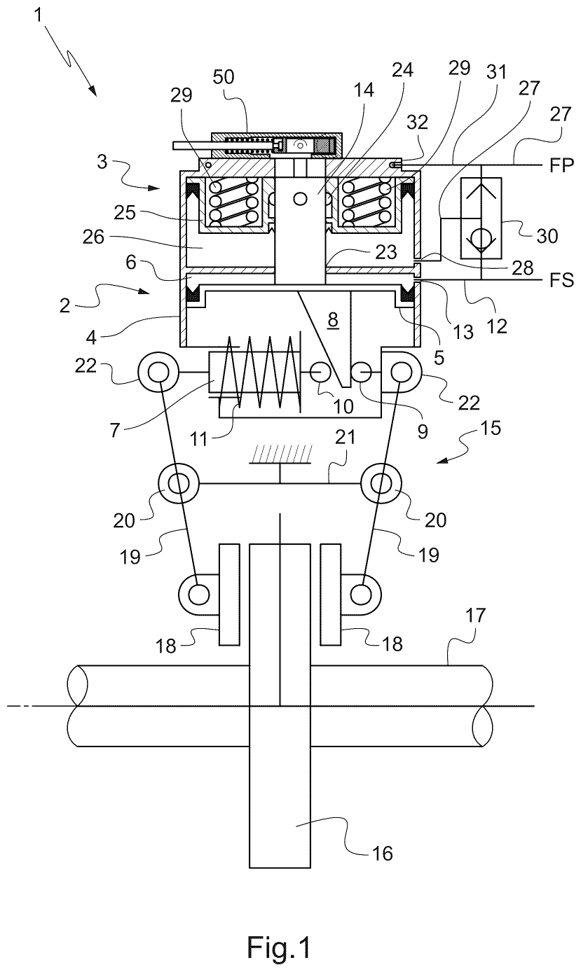

FIG. 1 schematically illustrates a railway braking system 1 including a railway brake cylinder 2 to which an actuation device 3 is coupled, hereinafter the actuator, configured to ensure for example a so-called parking brake or emergency brake function. The brake cylinder 2 includes a body 4, a braking piston 5 movable according to a first axial direction inside the body 4 and delimiting with the latter a pressure chamber 6 on the side of which the actuator 3 is coupled.

The brake cylinder 2 further includes a push rod 7 movable according to a second axial direction perpendicular to the first axial direction.

The braking piston 5 is attached to a corner part 8 having, for example a triangular section herein.

The corner part 8 is configured to cooperate with a first rolling stop 9 connected to the body 4 of the brake cylinder 2 and with a second rolling stop 10 connected to the push rod 7.

The brake cylinder 2 includes an elastic member 11, herein a spring, which is arranged between the body 4 and the push rod 7 in order to return the second rolling stop 10 against the corner part 8.

The railway braking system 1 is provided with a fluid circulation network and in particular herein a first conduit 12 connecting the pressure chamber 6 through a first inlet orifice 13 to a first pressurised fluid source denoted FS in FIG. 1.

The railway braking system 1 is further provided with a braking linkage 15 on which the brake cylinder 2 acts, and the railway brake linkage 15 is configured to act on a brake disc 16 mounted for example on an axle 17 of a railway vehicle, or directly on the wheel to be braked. The brake disc 16 is herein viewed in profile view.

The linkage 15 conventionally includes two brake pads 18 arranged on both sides of the brake disc 16 and which, in the absence of a load, are away from the brake disc 16 and upon a braking action, are urged by the linkage 15 against the brake disc 16 to slow down and/or stop the brake disc 16 by friction.

To this end, the linkage 15 includes two at least partially rigid levers 19 each including an upper arm and a lower arm secured to one another, each lever 19 being rotatably mounted about an axis 20 secured to a chassis 21 of the railway vehicle. The lower arm of each lever 19 is connected to one of the braking pads 18. In turn, the upper arm of each lever 19 is connected to an articulation 22.

The brake cylinder 2 is mounted between the two articulations 22, the body 4 being secured to one of these articulations 22 and the end of the push rod 7 being secured to the other articulation 22.

The operation of the brake cylinder 2 will be briefly described while assuming that the actuator 1, not yet described, is deactivated.

In FIG. 1, the brake cylinder 2 is shown in the standby position. In this position, the fluid pressure FS is not exerted, i.e. the first conduit 12 is for example set at the atmospheric pressure. The pressure chamber 6 then has a minimum volume, with the spring 11 which urges the second rolling stop 10 in the direction of the first rolling stop 9 causing rise of the corner part 8 and of the braking piston 5.

When the brake cylinder 2 is in the braking position, the first conduit 12 receives the pressurised fluid FS which fills the pressure chamber 6 and urges the braking piston 4 and the corner part 8 downwards, which has the effect of moving apart the first and second stops 9 and 10 and therefore the articulations 22. The volume of the pressure chamber 6 is maximum in this position. As soon as the pressure of the fluid FS is suppressed from the first conduit 12, the brake cylinder 2 returns to its standby position under the effect of the spring 11 while purging the fluid out of the pressure chamber 6.

As regards the actuator 3, it includes a body formed with the body 4 of the brake cylinder 2, which may include several portions mechanically connected and securely connected to one another.

The actuator 3 has an opening 23 formed opposite the braking piston 4 and opening into the pressure chamber 6 of the brake cylinder 2.

The opening 21 herein consists of a circular opening slidably receiving in part a locking device 14, herein with balls 24, of the actuator 3.

The actuator 3 includes a complementary braking piston 25 movably mounted in the body 4 and delimiting with the latter a complementary pressure chamber 26 throughout which the locking device 14 extends.

The fluid circulation network includes a second conduit 27 connecting the complementary pressure chamber 26 through a second inlet orifice 28 to a second pressurised fluid source denoted FP in FIG. 1.

The complementary braking piston 25 is movable between a high position and a low position. The schematic view of FIG. 1 shows the piston 24 in the high position.

The complementary braking piston 25 includes at its centre an orifice crossed by the locking device 14. Sealing between the locking device 16 and the piston 24 is ensured by a gasket.

Elastic members 29, formed in the present example by springs, permanently urge the complementary braking piston 25 towards its low position.

In normal operation, the complementary pressure chamber 26 is supplied with pressurised fluid FP so that the complementary braking piston 25 is in the high position. In the event of a defect for example on the pneumatic conduits, or in the event of emergency braking, or application of the parking brake, etc. the complementary pressure chamber 26 is no longer supplied and the springs 29 push the complementary braking piston 25 in the low position, generating movement of the locking device 16 and blocking of the braking piston 4 in a braking position, for example a parking position.

The railway braking system 1 is further provided with a pneumatic distribution member, herein formed by a so-called anti-superposition valve 30 which is configured to prevent the application of both the parking brake and the service brake, which might damage the brake cylinder 2 and in particular the push rod 7.

In particular, the anti-superposition valve 30 is, on the one hand, crossed by the second conduit 27 normally supplied with pressurised fluid FP and, on the other hand, connected to the first conduit 12 normally supplied with pressurised fluid FS.

Thus, if the first conduit 12 is supplied with pressurised fluid FS and the second conduit 27 is set at the atmosphere pressure or to the very least is not supplied with enough pressure to hold the springs 29, then it is the pressurised fluid FS which flows in the anti-superposition valve 30 and which holds the springs 29 to prevent these from applying a braking force complementary to that already applied by the pressurised fluid FS on the braking piston 5.

The actuator 1 further includes an unlocking device 50 which is configured to push back the locking device 14 or, in other words, to make it pass from a locking position into an unlocking position.

The unlocking device 50 is also supplied with pressurised fluid FP via a third conduit 31 throughout a third orifice 32 formed in the body 4, with the third conduit which is connected to the second conduit 27.

The unlocking device 50 is also called retention device, or valve.

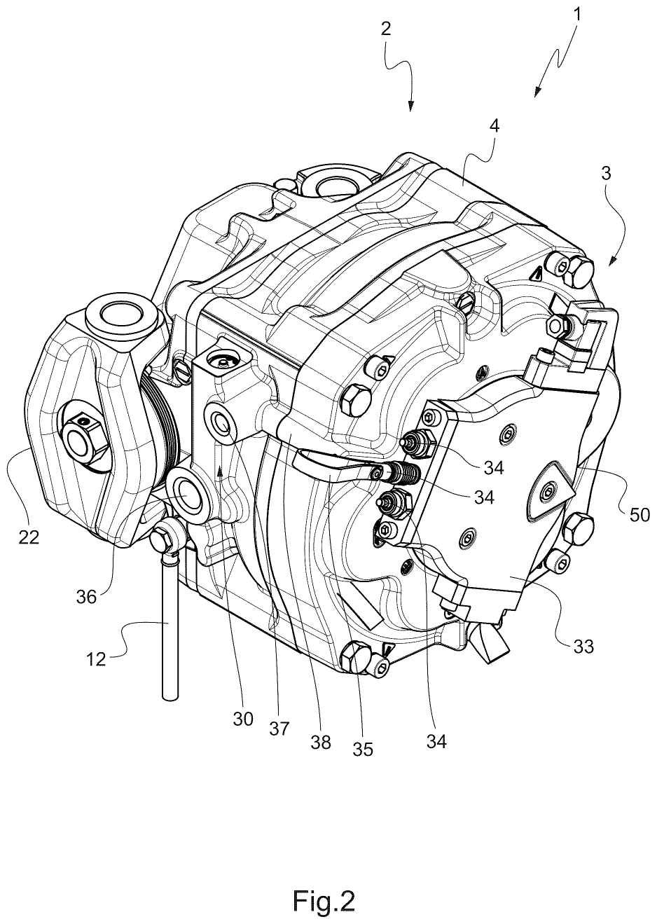

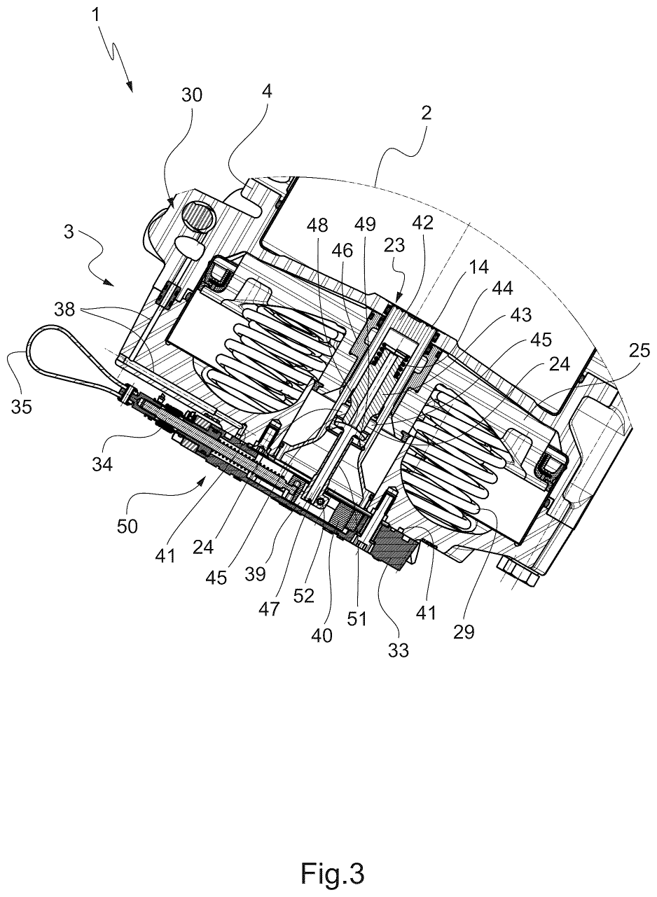

FIG. 2 illustrates in perspective the railway braking system 1 and in particular the brake cylinder 2 and the actuator 3 and FIG. 3 a partial section showing the actuator 3 instead.

The unlocking device 50 is provided with a distinct casing 33 mechanically connected on the body 4 of the brake cylinder 2.

The unlocking device 50 is further provided with a plurality of control rods 34 mounted so as to partially project from the casing 33 and to which control cables (not shown) are connected at one end and a control handle 35.

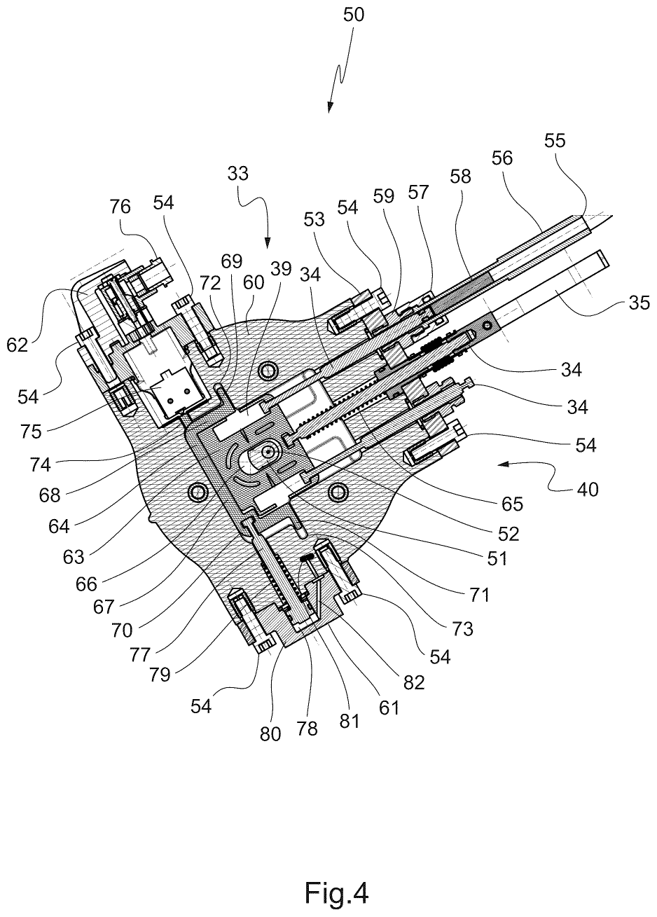

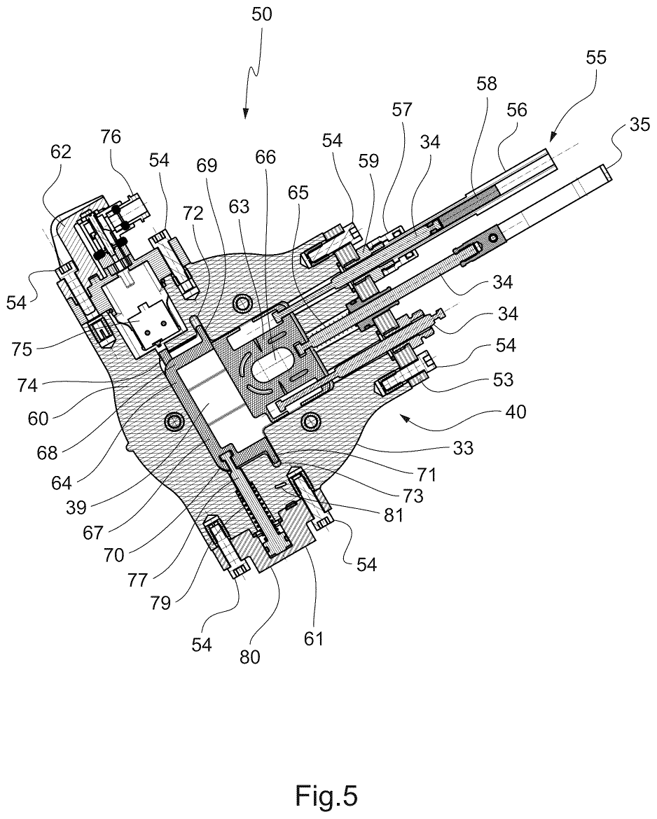

The unlocking device 50 is provided with a control mechanism 40 housed in a space 39 formed in the casing 33 and mechanically connected to an opposite end of the control rods 34 (cf. hereinafter in more detail with reference to FIGS. 4 and 5).

In FIGS. 2 and 3 also show the first conduit 12 supplying the brake cylinder 2 with pressurised fluid FS, and the anti-superposition valve 30 which is herein formed directly in the body 4.

In particular, the anti-superposition valve 30 includes a pressurised fluid inlet orifice FS 36 and a pressurised fluid inlet orifice FP 37, as well as an inner circulation conduit 38 formed in the body 4 to convey the pressurised fluid FP towards the unlocking device 50 (FIG. 2).

The inner circulation conduit 38 has a first portion extending in the body 4 according to the first axial direction and a second portion also extending in the body 4 according to the second axial direction perpendicular to the first direction, until opening into a fluid communication groove 41 formed at the surface of the body 4 against the casing 33 of the unlocking device 50 (FIG. 3).

In the illustrated example, the fluid communication groove 41 is circular.

FIG. 3 also shows in more detail the locking device 14 of the actuator 1.

In particular, in the illustrated example, the locking device 14 includes a push sleeve 42 sealingly fitting into the opening 23 by means of an O-ring gasket, as well as a slider 43 arranged inside the push sleeve 42 so as to be movable between a high position and a low position. It is here shown in the high position, corresponding to the locking position, whereas its low position corresponds to the unlocking position.

The slider 43 is permanently urged towards its locking position by a spring 44 arranged between the slider 43 and the push sleeve 42.

The actuator 1 further includes a hooking member 46 herein made in one-piece with the complementary braking piston 25 and which at least partially wraps the push sleeve 42. This hooking member 46 herein includes a first annular portion surrounding the push sleeve 42 and having an inner diameter similar to the latter so that it could slide along the latter. The hooking member 46 also includes a second annular portion having an upper inner diameter so as to form an indentation, the two portions being connected to one another by a flared intermediate portion and forming an annular bearing surface on the inner side.

The actuator 1 includes several balls 24 each arranged at least partially in the push sleeve 42 between the slider 43 and the hooking member 46. The balls 24 are configured to occupy a projecting position corresponding to the locking position of the slider 43 as well as a retracted position corresponding to the unlocking position of the slider 43.

When the slider 43 is in the locking position, the hooking member 46 is able to axially drive the push sleeve 42 via these balls 24. Conversely, when the slider 43 is in the unlocking position, the hooking member 46 is axially uncoupled from the push sleeve 42.

The slider 43 includes, at its end opposite to the spring 44, a lateral surface which is for example formed of receiving grooves 45 each extending according to the axis of this slider 43.

It should be noted that, functionally, the unlocking device 50 is configured to push the slider 43 back into the push sleeve 42 by compressing the spring 44.

Hence, the unlocking device 50 is adapted to drive the slider 43 from its locking position to its unlocking position, by pulling on the handle 35 and therefore on the control rod 34.

In particular, in the illustrated example, the unlocking device 50 includes a lever 47 formed by a rod having at one end a cambered base 48 whose concavity is directed towards the slider 43 and from which the rod extends. The cambered base 48 is herein arranged and held between the top of the slider 43 and an annular stop 49, whereas the rod extends from the cambered base 48 and is housed in a sheath 51 one end of which is housed in the space 39, or housing, of the casing 33 and by which the sheath 54 is articulated by a pivot 52.

Hence, it is the control mechanism 40 which is configured to actuate the lever 47 by articulating the sheath 51 at the pivot 52.

Indeed, when the maintenance agent wishes to stop the braking force exerted by the actuator 1, all he/she has to do is to actuate the handle 35 so as to move the control rod 34, the latter causing movement of the sheath 51 and therefore of the lever 47. The cambered base 48 of the lever 47 being held against the annular stop 49, the sheath 51 pivots about the pivot 52, or journal, whereas the lever 47 slides in this sheath 51 and the cambered base 48 tilts so that a portion of the latter exerts a force on the top of the slider 43 which is pushed back into its unlocking position.

The control mechanism 40, and more generally the casing 33 of the unlocking device 50, will now be described in more detail with reference to FIGS. 4 and 5.

The casing 33 has a body 60 which is herein made at least partially of a plastic material.

The casing 33 has a plate 53, for example made of plastic or of metal, and mechanically connected on an upper face of the body 60 via fastening members 54, for example of the screw type.

The control rods 34, three in number in the illustrated example, project throughout orifices formed in the plate 53.

On one of the control rods 34, located at the centre, is mechanically connected to the handle 35.

A control cable 55, formed by a core 58 at least partially wrapped by a sheath 56 and having at a free end a mounting member 57, of the nut type, configured to be mechanically connected on a complementary mounting member 59 mounted on the plate 53, is mechanically connected on another one of the control rods 34, located on one side. Such a control cable 55 may be configured to pull and/or push the associated control rod 34.

A control cable of the same type as that described hereinabove may be mechanically connected on the other one of the control rods 34, located on an opposite side.

The control mechanism 40 further has a control module 61 herein made at least partially of metal and mechanically connected on one side of the body 60 of the casing 33 via fastening members 54, for example of the screw type.

In the illustrated example, the control mechanism 40 also has a detection module 62 made at least partially of plastic or of metal, and herein also mechanically connected on an opposite side of the body 60 of the casing 33 via fastening members 54, for example of the screw type.

The space 39, or housing, is herein formed in the body 60 of the casing 33.

The control rods 34 extend into the body 60 and project into this space 39.

The control mechanism 40 is provided with a control member, herein a clevis 63 which is mounted movable according to a direction in the space 39 in the body 60 of the casing 33, between a so-called safety position (FIG. 4), corresponding to locking of the brake cylinder, and a so-called maintenance position (FIG. 5) corresponding to unlocking of the brake cylinder.

The clevis 63 has a central orifice 66 configured to receive the sheath 51 of the lever at the pivot 52 for articulation of the latter.

In the safety position of the clevis 63, the sheath 51 of the lever of the locking device 50 is received in the central orifice 66 of the clevis 63.

In the maintenance position of the clevis 63, the latter pivots the sheath 51 of the lever of the locking device 50, which could then come out from the central orifice 66 of the clevis 63.

The control rods 34 are mechanically connected to the clevis 63.

The control mechanism 40 has at least one return member 65 herein mounted around the control rod 34 located at the centre, between the plate 53 and the clevis 63.

The return member 65 is herein formed by a spring configured to urge the clevis 63 in its so-called safety position.

Thus, when the maintenance agent pulls on the handle 35, the clevis 63 is driven in translation in the housing 39 towards its maintenance position and, when the maintenance agent releases the handle 35, the clevis 63 is urged in the opposite direction and driven in translation in the housing 39 towards its safety position, unless the clevis 63 is held in the maintenance position.

In particular, the control mechanism 40 is further provided with a blocking member, herein a U-shaped lock 64 housed in the space 39 of the body 60 of the casing 33.

The lock 64 is mounted movable in translation according to a direction perpendicular to the direction of movement of the clevis 63 in the space 39 in the body 60.

The lock 64 has a bottom wall 67 from which project a first branch 68 having at its free end a first flange 69 which can be housed in a first cavity 72 formed in the body 60, and a second branch 70 extending opposite the first branch 68 and having at its free end a second flange 71 that can be housed in a second cavity 73 formed in the body 60.

The lock 64 further has a protuberance 74 projecting from the bottom wall 67 and/or from the first branch 68 and extending up to the detection module 62.

The detection module 62 has at least one sensor 75 housed in the body 60 and configured to detect the presence, or not, of the protuberance 74 and a connection socket 76 for collecting the information, for example electrical, representative of the position of the lock 64 in the control mechanism 40.

In turn, the control module 61 has a control piston 77 extending at least partially in the body 60 of the casing 33 and mechanically connected at one end to the second branch 70 of the lock 64.

The control module 61 further has a return member 79, herein formed by a spring mounted around the control piston 77 and configured to urge the space 39 of the body 33 away from the space 39, towards an outer cover 80 of the control module 61.

The outer cover 80 delimits with the control piston 77 a control chamber 78 which is supplied with pressurised fluid FP through a control orifice 81 formed in the body 60 of the casing 33 and which is located, on the one hand, in fluid communication with the groove 41 formed in the body 4 of the brake cylinder 2 and, on the other hand, in fluid communication with the control chamber 78 via a control conduit 82 running in the body 60 and in the outer cover 80.

The clevis 63 and the lock 64 are herein sized so that the clevis 63 could be received at least partially in a space delimited between the first and second branches 68 and 70 of the U-shaped lock 64.

In particular, when the control chamber 78 is supplied (FIG. 4), the control piston 77 is urged so that it pushes the lock 64 so that the clevis 63 could be housed therein.

The protuberance 74 is then in contact with the sensor 75 of the detection module 62.

The first flange 69 is housed in the first cavity 72.

In this safety configuration, the sheath 51 of the lever of the locking device 50 may be received in the central orifice 66 of the clevis 63.

If the control chamber 78 is no longer supplied, then the locking device 50 passes into the locking configuration (cf. hereinabove).

Neither the clevis 63 nor the lock 64 are moved, and the control piston 77 remains in position in the space 69.

If the maintenance agent pulls on the handle 35, or on a control cable 55, the clevis 63 is driven in translation towards the plate 53, coming out from the space delimited between the first and second branches 68 and 70 of the U-shaped lock 64.

The lock 64 is released and driven in translation by the control piston 77 itself urged by the spring 79.

In this maintenance configuration, the first flange 69 comes out at least partially from the first cavity 72 so as to be positioned under the clevis 63, whereas the second flange 71 is housed in the second cavity 73.

The clevis 63 is then locked in position, towards the plate, even when the maintenance agent releases the handle 35 or actuates a control cable 55 in the opposite direction.

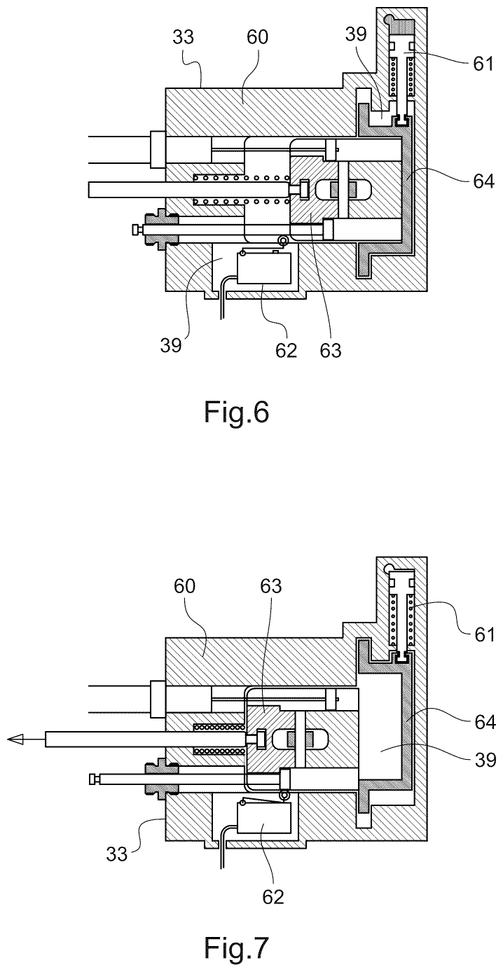

In a first variant illustrated in FIGS. 6 and 7, the detection module 62 and the control module 61 are directly integrated into the space 39 in the body 60 of the casing 33. The detection module 62 is further configured to be in contact with the clevis 63 and therefore to detect the position of the latter rather than the position of the lock 64.

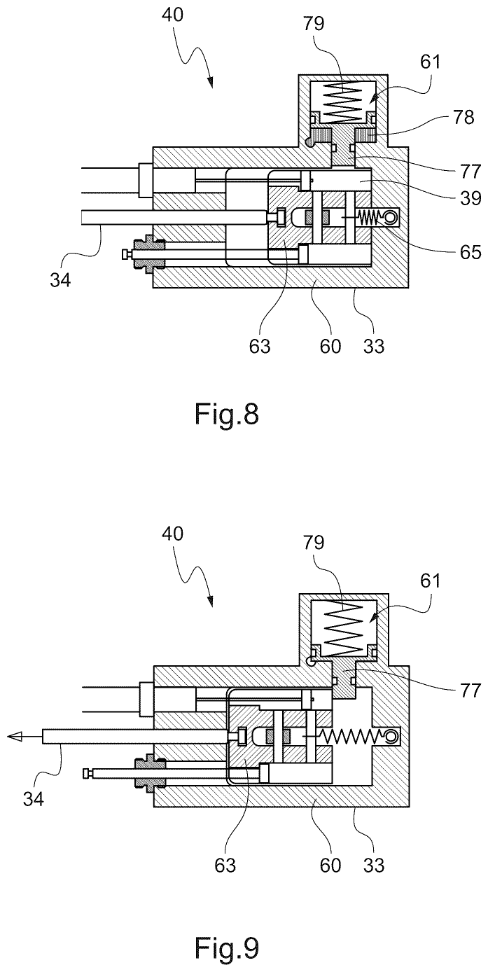

In a second variant illustrated in FIGS. 8 and 9, the control mechanism 40 is devoid of a detection module. What is more, the lock is formed directly by the control piston 77 which, when it is deployed, blocks the clevis 63 in position. The control pressure chamber 78 and the return member 79 are also inverted. In other words, in the presence of a pressurised fluid FP, the control piston 77 is retracted, or moved back, and does not block the clevis 63, whereas in the absence of a pressurised fluid FP, the control piston 77 is deployed, or moved forward, and blocks the clevis 63. Furthermore, in FIGS. 8 and 9, the return member 65 is not mounted around the control rod 34 but opposite thereto, in the space 39 between the clevis 63 and the body 60 of the casing 33.

In a non-illustrated variant, the casing of the unlocking device may be made of metal rather than plastic, and the cover of the control module may be made of plastic rather than metal.

More generally, the invention is not limited to the described and illustrated examples.

1. A railway braking system for a railway vehicle, including a brake cylinder (2) configured to act on braking members (18) of the railway vehicle, an actuation device (14) configured to lock the brake cylinder in a braking position and an unlocking device (50) configured to unlock the actuation device by actuation of a control mechanism (40), wherein the control mechanism includes a control member (63) movable in translation according to a first direction and housed in a casing (33) of the unlocking device connected to the brake cylinder, the control member being configured to cooperate with the actuation device, and a blocking member (64, 77) mounted movable in translation according to a second direction perpendicular to the first direction of movement of the control member and housed in the casing of the unlocking device, the control mechanism being configured so that, when the actuation device is in a locking position of the brake cylinder and the control member is urged and moved towards a maintenance position in which it is configured to make the actuation device pass into an unlocking position, the blocking member is urged and moved in a position in which it blocks the control member in position.

2. The railway braking system of claim 1, wherein the unlocking device (50) includes at least one control rod (34) connected at one end to the control member (63) and mounted so as to partially project from the casing (33) so as to be urged from outside of the casing.

3. The railway braking system of claim 1, wherein the control member is formed by a clevis (63) movably mounted in a space (39) formed in a body (60) of the casing (33), between a safety position, corresponding to locking the brake cylinder (2), and a maintenance position corresponding to unlocking the brake cylinder, with the clevis which has a central orifice (66) configured to receive a lever (47) of the actuation device (14).

4. The railway braking system of claim 3, wherein the blocking member is formed by a U-shaped lock (64) housed in the space (39) formed in the body (60) of the casing (33), with the lock which has a bottom wall (67) from which project a first branch (68) having at its free end a first flange (69) which can be housed in a first cavity (72) formed in the body of the casing, and a second branch (70) extending opposite the first branch and having at its free end a second flange (71) which can be housed in a second cavity (73) formed in the body of the casing.

5. The railway braking system of claim 4, wherein the clevis (63) and the lock (64) are sized so that the clevis is received at least partially in a space delimited between the first and second branches (68, 70) of the lock.

6. The railway braking system of claim 5, wherein the control mechanism (40) has a control module (61) provided with a control piston (77) extending at least partially in the body (60) of the casing (33), a control chamber (78) supplied with pressurized fluid (FP) via a control orifice (81) formed in the body of the casing and which is in fluid communication with a groove (41) formed in a body (4) of the brake cylinder (2) and wherein the control orifice is in fluid communication with the control chamber via a control line (82) running at least in the body of the casing.

7. The railway braking system of claim 6, wherein when the control chamber (78) is supplied, the control piston (77) is urged so that it pushes the lock (64) so that the clevis (63) is housed therein, the first flange (69) is housed in the first cavity (72), and in the safety position of the clevis, the lever (47) of the actuation device (14) is partially received in the central orifice (66) of the clevis.

8. The railway braking system of claim 6, wherein when the control chamber (78) is no longer supplied and the clevis (63) is driven in translation towards the maintenance position, the clevis comes out from the space delimited between the first and second branches (68, 70) of the lock (64), which is released and driven in translation by the control piston (77) itself urged by a spring member (79) and, in the maintenance position, the first flange (69) comes out at least partially from the first cavity (72) to be positioned under the clevis whereas the second flange (71) is housed in the second cavity (73), thereby blocking the clevis in position.

9. The railway braking system-according of claim 6, wherein the control piston (77) is mechanically connected at one end to the second branch (70) of the lock (64) and the control module (61) further has a return member (79) mounted around the control piston (77) and configured to urge it away from the space (39) of the body (60) of the casing (33), towards an outer cover (80) of the control module, which the outer cover delimits with the control piston the control chamber (78) which is supplied with the pressurized fluid (FP).

10. The railway braking system of claim 1, wherein the control mechanism (40) has a detection module (62) provided with at least one sensor (75) housed in a body (60) of the casing (33) and configured to detect the position of the control member (63) and/or of the blocking member (64).

11. The railway braking system of claim 1, further comprising a parking brake or a service brake cylinder configured to act on the braking members of the railway vehicle with the actuation device (50) which is configured to lock the brake cylinder in a parking brake configuration.

12. The railway braking system of claim 1, wherein the railway braking system is configured to act on mechanical members (18) of the railway vehicle and the unlocking device (50) of which is configured to unlock the actuation device (14) by actuation of a control mechanism (40).

13. The railway braking system of claim 2, wherein the unlocking device (50) is urged from outside of the casing by a handle (35) and/or a control cable (55).

14. The railway braking system of claim 2, wherein the unlocking device (50) is urged from outside of the casing by a control cable (55).

15. The railway braking system of claim 11, wherein the parking brake or the service brake cylinder act on brake discs of the railway vehicle.

16. The railway braking system of claim 11, wherein the parking brake or the service brake cylinder act on wheels of the railway vehicle.
